(19) United States
(12) Patent Application Publication
(10) Pub. No.: US 2012/0227090 A1
(43) Pub. Date: Sep. 6, 2012

(54) WIRELESS COMMUNICATION TERMINAL

(75) Inventor: Kazuyuki Shibuya, Sagamihara-shi (JP)

(73) Assignee: OLYMPUS CORPORATION, Tokyo (JP)

(21) Appl. No.: 13/400,832

(22) Filed: Feb. 21, 2012

(30) Foreign Application Priority Data
Mar. 2, 2011 (JP) 2011-045212

(51) Int. Cl. H04W 12/00

(52) U.S. Cl. 726/4

(57) ABSTRACT

A wireless communication terminal may include a trigger receiving unit that receives a trigger for starting first setup process in a state in which the wireless communication terminal does not participate in wireless network, a transmitting unit that transmits an acquisition request of setup information representing a participation setup process performed by another wireless communication terminal after receiving the trigger, a receiving unit that receives a response including the setup information transmitted from the other wireless communication terminal receiving the acquisition request, and a control unit that performs control such that the transmitting unit transmits error information representing that wireless communication terminals performing the first setup process are detected to the wireless communication terminals, and performs control such that the participation setup process performed by its own wireless communication terminal is set as second setup process when responses including the setup information representing the first setup process are received.

### BACKGROUND OF THE INVENTION

1. Field of the Invention

The present invention relates to a wireless communication terminal that performs a participation setup process with a wireless communication terminal, which is participating in a wireless network, so as to participate in the wireless network. Also, the present invention relates to a wireless communication terminal that is participating in a wireless network and performs a participation setup process with a wireless communication terminal that does not participate in the wireless network.

Priority is claimed on Japanese Patent Application No. 2011-045212, filed Mar. 2, 2011, the content of which is incorporated herein by reference.

2. Description of the Related Art

All patents, patent applications, patent publications, scientific articles, and the like, which will hereinafter be cited or identified in the present application, will hereby be incorporated by reference in their entirety in order to describe more fully the state of the art to which the present invention pertains.

In the past, in wireless communication terminals with a wireless local area network (LAN) function, it was necessary to set various information (network setup information) such as a network ID (SSID), an authentication method, an encryption scheme, and an encryption key in order to participate in a network (an infrastructure network) provided by an access point (hereinafter referred to as “AP”). Further, it was necessary to input various settings on the wireless communication terminal in order to perform the setting. Since inputting the setting was complicated, it was not easy, in particular, for a user who was less attuned to a wireless LAN technique to perform the setting.

In order to solve the above-mentioned problem, Wi-Fi Protected Setup™ Specification 1.0 (hereinafter abbreviated as “WPS”) has been disclosed as an industry standard technique of a wireless LAN for allowing a wireless communication terminal to participate in an infrastructure network through a simple network setup information setting process (“participation set-up process”), which is available, for example, from https://www.wi-fi.org/knowledge_center_overview.php?type=4.

Several setup methods are specified in WPS. For example, in a first setup method (hereinafter referred to as a “push button configuration (PBC) method”), the participation setup process is performed such that a user pushes an actual button, or a button on a screen using a graphical user interface (GUI) function (graphical user interface function) in each of a non-participating wireless communication terminal that has a wireless LAN function and desires to participate in a network and a wireless communication terminal (mostly, AP) that has already participated in the network, and a fixed value defined in WPS is used in both wireless communication terminals as identification information for the participation setup process. Further, in a second setup method (hereinafter referred to as a “personal identification number (PIN) method”), the participation setup process is performed such that a user inputs a PIN code generated as an arbitrary value and displayed on a screen of non-participating wireless communication terminal to a wireless communication terminal (mostly AP) that has participated as identification information for the participation setup process.

By performing the participation setup process through these setup methods, the network setup information held in the AP can be safely transferred to the wireless communication terminal. After the transfer of the network setup information by WPS is completed, the user need not perform an annoying task such as an input of the encryption key or the like. The wireless communication terminal can set the transferred network setup information, execute an authentication process with the AP as necessary, and perform data communication with the AP. Further, the PIN code may be input to the AP using a browser from another terminal in a network to which the AP belongs. Of the setup methods, the PBC method has been widely used since the PBC method is more convenient for the user than the PIN method and can be executed by an intuitive operation.

In recent years, an ad-hoc mode that allows the wireless communication terminals to perform direct wireless LAN communication, unlike an infrastructure mode needing an AP, has started to be widely used in portable terminals such as a game machine and a camera. In the ad-hoc mode, there is no terminal that becomes central in a network like an AP in the infrastructure mode, and each terminal performs communication on an equal level.

Even in the ad-hoc mode, it is complicated to set the network setup information like the infrastructure mode. However, it is desirable to allow a conventional WPS to be performed in an ad-hoc network. At this time, since there is no terminal that functions to manage a network like the AP in the infrastructure mode in the ad-hoc mode, for example, in the PBC method, when a button is pushed on any one of wireless communication terminals that have participated, the participation setup process with a non-participating wireless communication terminal can be performed.

FIGS. 10A to 10C, 11A to 11C, and 12A to 12D are reference diagrams illustrating a process of causing a non-participating wireless terminal to participate in an ad-hoc network. FIGS. 10A to 10C and FIGS. 11A to 11C illustrate an example of causing a plurality of non-participating terminals to participate in the ad-hoc network by the PBC method of WPS in a state in which there are the plurality of wireless communication terminals which have participated in the existing the ad-hoc network. As illustrated in FIG. 10A, wireless communication terminals 130 and 131 have already participated in an ad-hoc network 180, and wireless communication terminals 132 and 133 do not participate in the ad-hoc network 180 yet.

In order to have the plurality of non-participating wireless communication terminals participate in the ad-hoc network by the PBC method, a user pushes buttons on any one participating wireless communication terminal 130 and one non-participating wireless communication terminal 132, which is desired to firstly participate in the ad-hoc network (FIG. 10A), so that the participation setup process is executed between these wireless communication terminals (FIG. 10B). If the participation setup process is completed, then the participation setup process has been performed so that the non-participating wireless communication terminal 132 becomes a participating wireless communication terminal in the ad-hoc network 180 (FIG. 10C).

After visually confirming completion of the participation setup process, subsequently, the user pushes buttons on any one participating wireless communication terminal 130 and one wireless communication terminal 133 desired to participate next (FIG. 11A). In FIG. 11A, the button is pushed down in the participating wireless communication terminal 130, which is the participating wireless communication terminal whose button has been pushed down in the previous participation setup process, however, the button may be pushed down in any other participating wireless communication terminal. The participation setup process is executed between the wireless communication terminals whose buttons are pushed down (FIG. 11B). If the participation setup process is completed, then the participation setup process has been performed so that the non-participating wireless communication terminal 133 becomes a participating wireless communication terminal in the ad-hoc network 180 (FIG. 11C). In this way, a plurality of non-participating wireless communication terminals can become participating wireless communication terminals in the existing ad-hoc network.

The participation setup process of WPS requires an exchange of various messages and a complicated calculation during processing. Thus, it may takes tens of seconds to complete the participation setup process if it is long. In the above-described procedure, the user visually confirms completion of the participation setup process and then pushes the button down again. Therefore, a time, in which the user is constrained to push the button down, takes long. In addition, it takes time for all non-participating wireless communication terminals to become participating wireless communication terminals.

Meanwhile, as illustrated in FIGS. 12A to 12D, when buttons are pushed down in both wireless communication terminals 130 and 132 (FIG. 12A), buttons may be pushed down in the participating wireless communication terminal 131 and the non-participating wireless communication terminal 133 (FIG. 12B), which are different from the participating wireless communication terminal 130 and the non-participating wireless communication terminal 132 whose buttons are first pushed down, without waiting for completion of the participation setup process.

In this case, the non-participating wireless communication terminal 133 detects a plurality of participating wireless communication terminals whose buttons have been pushed down (FIG. 12C). However, it is difficult for the non-participating wireless communication terminal 133 to decide the participating wireless communication terminal, which will perform the participation setup process, is performed with which participating wireless communication terminals whose buttons have been pushed down. Thus, an error representing that a plurality of wireless communication terminals have been detected in WPS occurs (FIG. 12D).

### SUMMARY

The present invention provides a wireless communication terminal which is capable of reducing a standby time of a participation setup process and reducing a time taken until participation of all non-participating wireless communication terminals is completed when a plurality of non-participating wireless communication terminals join an existing wireless network.

A wireless communication terminal, wherein a process, in which an authentication identifier necessary for participating in a wireless network is a fixed value, is set as a first setup process, and a process, in which the authentication identifier is variable, is set as a second setup process in a participation setup process, which a non-participating wireless communication terminal, which does not participate in the wireless network, performs with a wireless communication terminal, which is participating in the wireless network, in order to participate in the wireless network, the wireless communication terminal may include: a trigger receiving unit that receives a trigger for starting the first setup process in a state in which the wireless communication terminal does not participate in the wireless network; a transmitting unit that transmits an acquisition request of setup information representing a participation setup process performed by another wireless communication terminal after receiving the trigger; a receiving unit that receives a response including the setup information transmitted from the other wireless communication terminal that has received the acquisition request; and a control unit that performs control such that the transmitting unit transmits error information representing that a plurality of wireless communication terminals performing the first setup process are detected to the plurality of wireless communication terminals, and performs control such that the participation setup process performed by its own wireless communication terminal is set as the second setup process when responses including the setup information representing the first setup process are received from the plurality of wireless communication terminals.

When a response is received from at least one of the plurality of wireless communication terminals in response to the error information transmitted by the transmitting unit, the control unit may perform control such that the transmitting unit transmits start information representing a start of the second setup process to a wireless communication terminal that has transmitted the response to the error information.

A wireless communication terminal, wherein a process, in which an authentication identifier necessary for participating in a wireless network is a fixed value, is set as a first setup process, and a process, in which the authentication identifier is not a fixed value, is set as a second setup process in a participation setup process, which a non-participating wireless communication terminal, which does not participate in the wireless network, performs with a wireless communication terminal, which is participating in the wireless network, in order to participate in the wireless network, the wireless communication terminal may include: a trigger receiving unit that receives a trigger for starting the first setup process in a state in which the wireless communication terminal is participating in the wireless network; a receiving unit that receives an acquisition request of setup information representing a participation setup process performed by another wireless communication terminal from the non-participating wireless communication terminal after receiving the trigger; a transmitting unit that transmits a response including the setup information representing the first setup process to the non-participating wireless communication terminal when the acquisition request is received; and a control unit that performs control such that the participation setup process performed by its own wireless communication terminal is set as the second setup process when the receiving unit receives error information representing that a plurality of wireless communication terminals performing the first setup process are detected in a state in which the wireless communication terminal is not executing the first setup process with any of wireless communication terminals that do not participate in the wireless network.

The control unit may perform control of waiting for a start of the second setup process until the receiving unit receives start information representing a start of the second setup process from a wireless communication terminal that is a transmission source of the error information.

In the present invention, when there are a plurality of wireless communication terminals that perform a first setup process, a participation setup process performed in a wireless communication terminal that has received a trigger for starting the first setup process is set as a second setup process. Thus, a situation in which it is difficult to decide the wireless communication terminal that will perform the participation setup process from among a plurality of participating wireless communication terminals in a wireless network does not occur. Thus, when a plurality of non-participating wireless communication terminals join an existing wireless network, the standby time of the participation setup process can be reduced, and a time, which takes until for all non-participating wireless communication terminals to become participating wireless communication terminals, can be reduced.

### BRIEF DESCRIPTION OF THE DRAWINGS

The above features and advantages of the present invention will be more apparent from the following description of certain preferred embodiments taken in conjunction with the accompanying drawings, in which:

FIG. 1 is a block diagram illustrating a configuration of a wireless communication terminal in accordance with a first preferred embodiment of the present invention;

FIGS. 2, 3, 4, 5 and 6 are flowcharts illustrating a procedure of an operation of the wireless communication terminal in accordance with the first preferred embodiment of the present invention;

FIGS. 7, 8 and 9 are sequence diagrams illustrating a communication procedure between the wireless communication terminals in accordance with the first preferred embodiment of the present invention; and

FIGS. 10A, 10B, 10C, 11A, 11B, 11C, 12A, 12B, 12C and 12D are reference diagrams illustrating a process of causing a non-participating wireless terminal to participate in an ad-hoc network.

### DETAILED DESCRIPTION OF THE PREFERRED EMBODIMENTS

The present invention will be now described herein with reference to illustrative preferred embodiments. Those skilled in the art will recognize that many alternative preferred embodiments can be accomplished using the teaching of the present invention and that the present invention is not limited to the preferred embodiments illustrated for explanatory purpose.

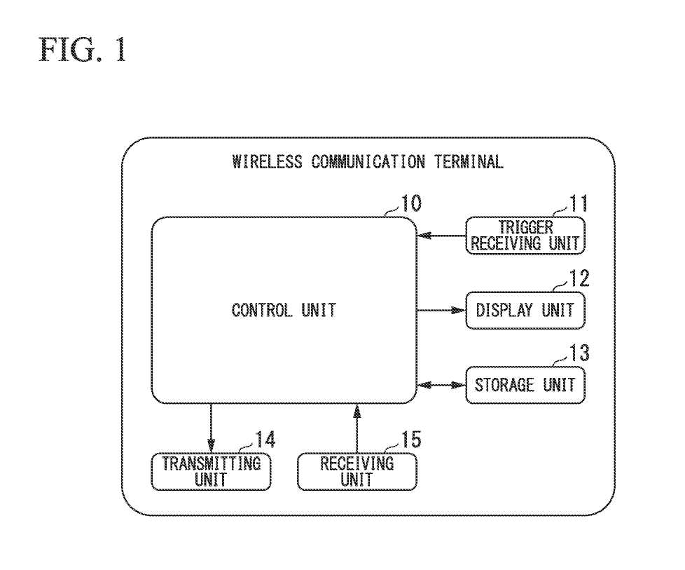

FIG. 1 is a block diagram illustrating a configuration of a wireless communication terminal (wireless communication terminals 1 to 4, which will be described later) in accordance with a first preferred embodiment of the present invention. The wireless communication terminal illustrated in FIG. 1 includes a control unit 10, a trigger receiving unit 11, a display unit 12, a storage unit 13, a transmitting unit 14, and a receiving unit 15.

The control unit 10 controls the respective components of the wireless communication terminal. The trigger receiving unit 11 includes an operation member such as a button operated by a user. The trigger receiving unit 11 detects generation of a trigger for starting a participation setup process and receives the trigger. The trigger receiving unit 11 may receive the trigger of either a participation setup process by the PBC method (a first setup process) or a participation setup process by the PIN method (a second setup process).

In the PBC method, the trigger receiving unit 11 receives the trigger for starting the participation setup process by detecting that the user has pushed the button functioning as the operation member, that the user has pushed the button on the screen of the display unit 12 using the GUI function, or that selection of a menu corresponding to pushing-down of the button has been made. Further, in the PIN method, the trigger receiving unit 11 receives the trigger for starting the participation setup process by detecting that a setup application has been activated (that an application has been activated by the user's operation or an application has been automatically activated after the wireless communication terminal is powered on). When the trigger for starting the participation setup process has been received, the trigger receiving unit 11 outputs a signal representing generation of the trigger corresponding to the setup method to the control unit 10. The control unit 10 detects generation of the trigger corresponding to the setup method based on the signal from the trigger receiving unit 11.

The display unit 12 displays various kinds of information to be provided to the user. The storage unit 13 stores various kinds of information used for processing in the wireless communication terminal. The transmitting unit 14 transmits information or data to another wireless communication terminal based on control from the control unit 10. The receiving unit 15 receives information or data from another wireless communication terminal. When information or data has been received from the other wireless communication terminal, the receiving unit 15 outputs the received information or data to the control unit 10. The information or data output to the control unit 10 is appropriately stored in the storage unit 13.

In the first preferred embodiment, when the user causes a plurality of non-participating wireless communication terminals to participate in the existing ad-hoc network based on the BPC method of WPS, the non-participating wireless communication terminal may detect that a plurality of wireless communication terminals in the ad-hoc network are operating based on the PBC method. In this case, the setup method is switched to the PIN method in the non-participating wireless communication terminals and one wireless communication terminal which is not executing the participation setup process among the wireless communication terminals in the ad-hoc network. As a result, a situation in which the non-participating wireless communication terminal cannot determine the participation setup process should be performed with which participating wireless communication terminal does not occur.

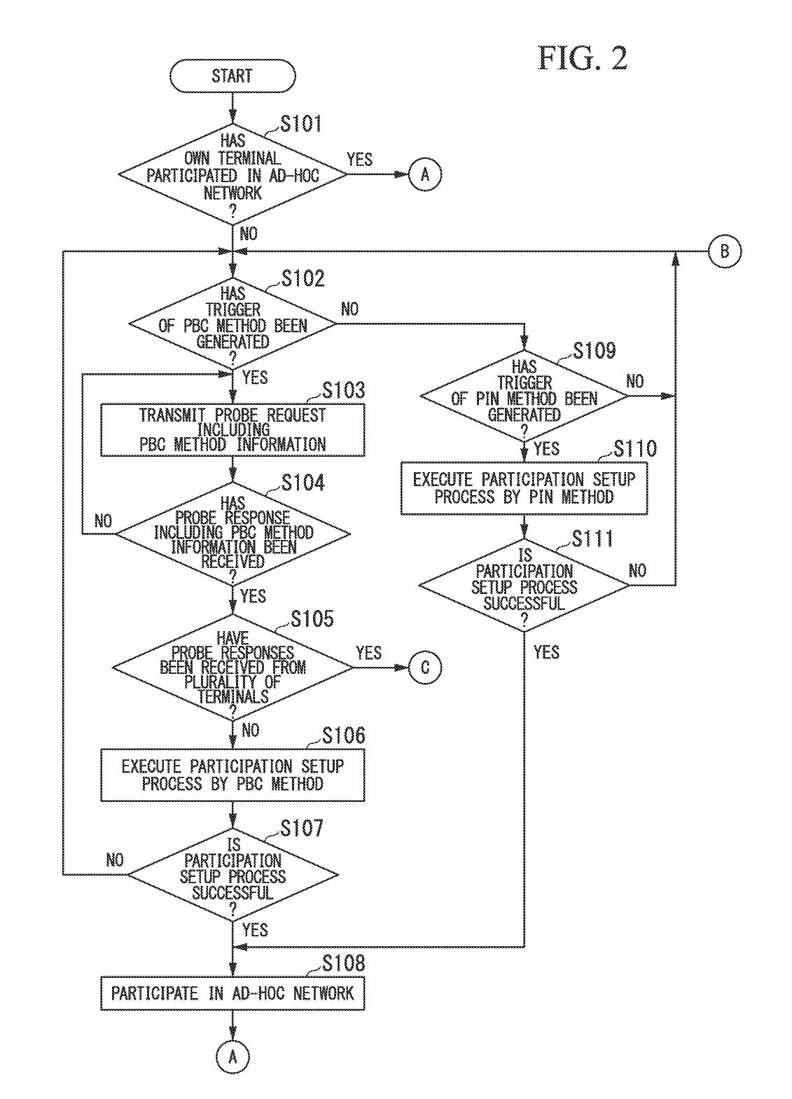

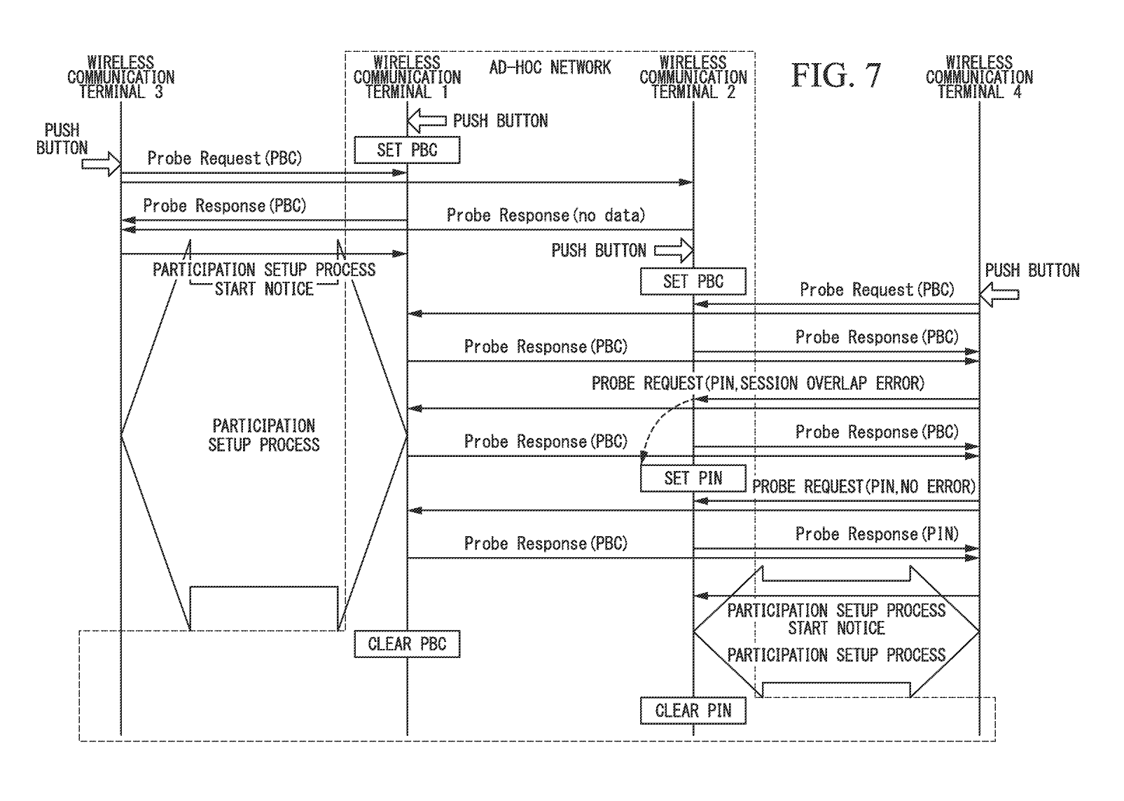

Next, a detailed operation of a wireless communication terminal will be described with reference to FIGS. 2 to 9. FIGS. 2 to 6 are flowcharts illustrating a procedure of an operation of a wireless communication terminal in accordance with the first preferred embodiment of the present invention. FIGS. 7 to 9 are sequence diagrams illustrating a communication procedure between wireless communication terminals in accordance with the first preferred embodiment of the present invention according to FIGS. 2 to 6. When FIGS. 2 to 6 are referred to after referring to FIGS. 7 to 9, operations illustrated FIGS. 7 to 9 will be more clearly understood.

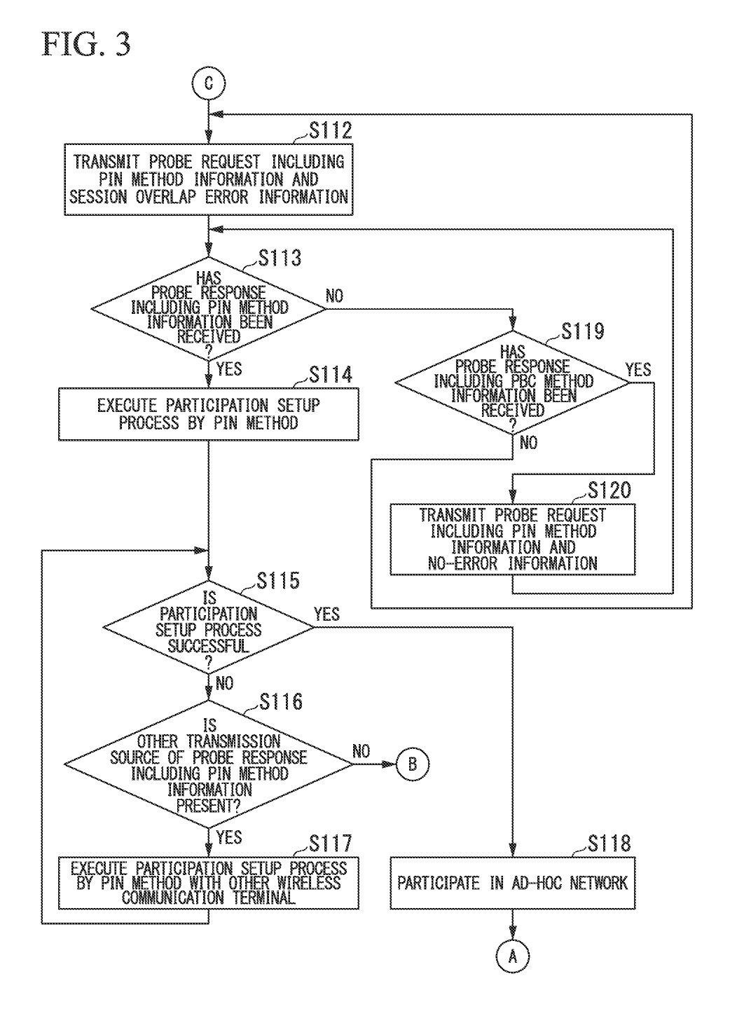

FIGS. 2 and 3 mainly illustrate operations of non-participating wireless communication terminals that do not participate in the ad-hoc network. First, the control unit 10 determines whether or not its own wireless communication terminal has participated in the ad-hoc network (step S101). The determination in step S101 is made based on an internal state of the wireless communication terminal. The storage unit 13 stores the network setup information. Thus, when a TSF timer of the ad-hoc network corresponding to the network setup information remains synchronized with its own TSF timer, it is determined that its own wireless communication terminal has participated in the ad-hoc network. However, when the TSF timer of the ad-hoc network corresponding to the network setup information does not remain synchronized with its own TSF timer, it is determined that its own wireless communication terminal has not participated in the ad-hoc network.

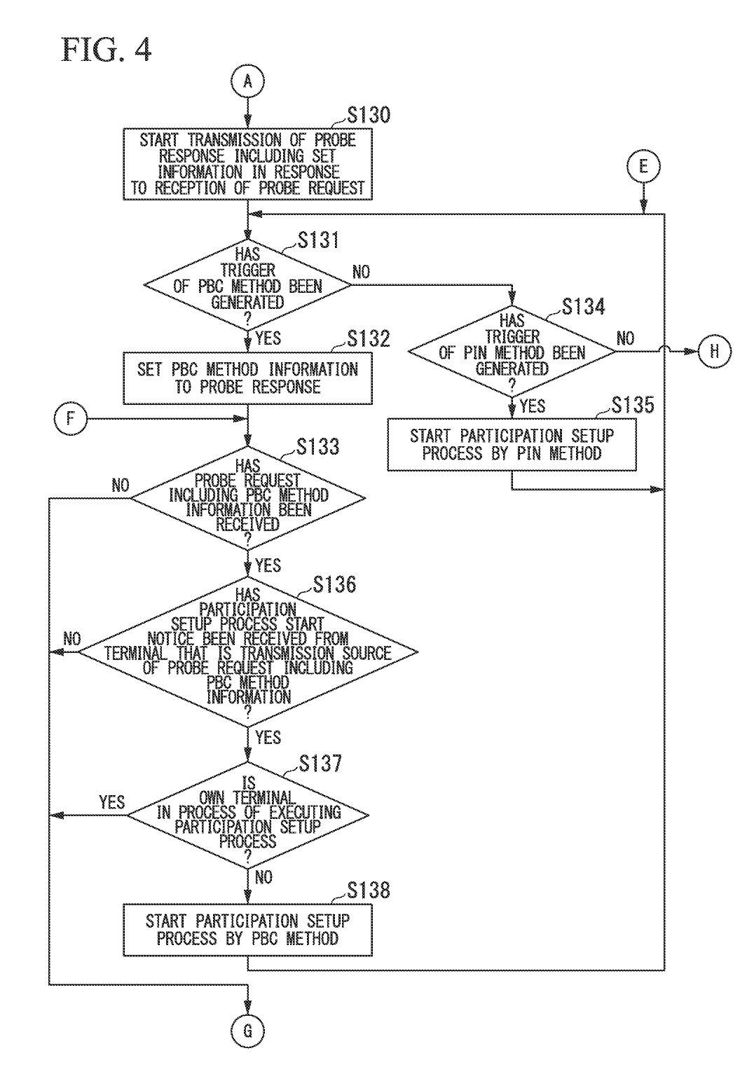

When it is determined that its own wireless communication terminal has participated in the ad-hoc network, the process proceeds to step S130 of FIG. 4. However, when it is determined that its own wireless communication terminal has not participated in the ad-hoc network, the control unit 10 monitors a status of the trigger receiving unit 11, and determines whether or not the trigger for starting the participation setup process by the PBC method has been generated (step S102).

When it is determined that the trigger for starting the participation setup process by the PBC method has been generated, the control unit 10 sets the setup method of its own wireless communication terminal to the PBC method, and releases the generated trigger. Here, it is assumed that similarly in each step in which generation of a subsequent trigger has been confirmed, the generated trigger is released. In addition, the control unit 10 controls the transmitting unit 14 such that a probe request (an acquisition request) including PBC method information (setup information) representing that the setup method of its own wireless communication terminal is the PBC method is transmitted. The transmitting unit 14 transmits the probe request based on control from the control unit 10 (step S103). A transmission destination of the probe request is broadcast.

Subsequently, the control unit 10 determines whether or not a probe response including PBC method information has been received from another wireless communication terminal (step S104). When it is determined that the probe response including the PBC method information has not been received from another wireless communication terminal, the process proceeds to step S103. However, when it is determined that the probe response including the PBC method information has been received from another wireless communication terminal, the control unit 10 determines whether or not the probe responses including the PBC method information have been received from a plurality of wireless communication terminals (step S105).

When it is determined that the probe responses including the PBC method information have been received from the plurality of wireless communication terminals, the process proceeds to step S112 of FIG. 3. However, when it is determined that the probe response including the PBC method information has been received from one wireless communication terminal, the control unit 10 controls the respective components of the wireless communication terminal to execute the participation setup process by the PBC method together with the wireless communication terminal that is a transmission source of the probe response including the PBC method information (step S106). In the participation setup process by the PBC method, a participation setup process start notice (start information) is first transmitted, various messages necessary for receiving the network setup information are exchanged between a transmission source and a transmission destination of the participation setup process start notice, and then the network setup information is received. After the participation setup process is finished, the control unit 10 determines whether or not the participation setup process is successful (step S107).

When it is determined that the participation setup process is unsuccessful, the process proceeds to step S102. However, when the participation setup process is successful, the control unit 10 executes an authentication process as necessary based on the network setup information acquired in the participation setup process, and participates in the ad-hoc network in which the wireless communication terminal which is a counterpart of the participation setup process has participated (step S108). The participation in the ad-hoc network is completed by causing its own TSF timer to be synchronized with the value of the TSF timer included in the received probe response. Subsequently, the process proceeds to step S130 of FIG. 4.

Meanwhile, when it is determined in step S102 that the trigger for starting the participation setup process by the PBC method has not been generated, the control unit 10 monitors the status of the trigger receiving unit 11, and determines that the trigger for starting the participation setup process by the PIN method has been generated (step S109). When it is determined that the trigger for starting the participation setup process by the PIN method has not been generated, the process proceeds to step S102. However, when it is determined that the trigger for starting the participation setup process by the PIN method has been generated, the control unit 10 sets the setup method of its own wireless communication terminal to the PIN method. In addition, the control unit 10 controls the respective components of the wireless communication terminal to execute the participation setup process by the PIN method together with the wireless communication terminal that is a transmission source of a probe response including PIN method information (step S110). In the participation setup process by the PIN method, similarly to the participation setup process by the PBC method, transmission of the participation setup process start notice (start information), an exchange of various messages, and reception of the network setup information are performed. In addition, in the participation setup process by the PIN method, before the participation setup process start notice is transmitted or while various messages are exchanged, a PIN code is displayed.

After the participation setup process is finished, the control unit 10 determines whether or not the participation setup process is successful (step S111). When it is determined that the participation setup process is unsuccessful, the process proceeds to step S102. However, when the participation setup process is successful, the process proceeds to step S108.

Meanwhile, when it is determined in step S105 that the probe responses including the PBC method information have been received from the plurality of wireless communication terminals, it is determined that the probe responses have been received from the plurality of wireless communication terminals that have participated in the ad-hoc network and have generated the trigger for starting the participation setup process by the PBC method. In this case, the control unit 10 sets the setup method of its own wireless communication terminal to the PIN method. In addition, the control unit 10 performs controls such that the transmitting unit 14 transmits a probe request including PIN method information representing that the setup method of its own wireless communication terminal is the PIN method and session overlap error information representing that a plurality of wireless communication terminals performing the participation setup process by the PBC method have been detected. The transmitting unit 14 transmits the probe request based on control from the control unit 10 (step S112).

Subsequently, the control unit 10 determines whether or not the probe response including the PIN method information has been received from another wireless communication terminal (step S113). When it is determined that the probe response including the PIN method information has not been received from another wireless communication terminal, the control unit 10 determines whether or not the probe response including the PBC method has been received from another wireless communication terminal (step S119).

When it is determined that the probe response including the PBC method has not been received from another wireless communication terminal, the process proceeds to step S112. However, when it is determined that the probe response including the PBC method has been received from another wireless communication terminal, the control unit 10 performs control such that the transmitting unit 14 transmits the probe request including the PIN method information representing that the setup method of its own wireless communication terminal is the PIN method and no-error information. Here, the no-error information is included in the probe request, however, error information may not be included in the probe request. The transmitting unit 14 transmits the probe request based on control from the control unit 10 (step S120). Subsequently, the process proceeds to step S113.

However, when it is determined in step S113 that the probe response including the PIN method information has been received from another wireless communication terminal, the control unit 10 controls the respective components of the wireless communication terminal to execute the participation setup process by the PIN method together with the wireless communication terminal that is a transmission source of the probe response including the PIN method information (step S114). After the participation setup process is finished, the control unit 10 determines whether or not the participation setup process is successful (step S115).

When the participation setup process is successful, the control unit 10 executes an authentication process as necessary based on the network setup information acquired in the participation setup process, and participates in the ad-hoc network in which the wireless communication terminal which is a counterpart of the participation setup process has participated (step S118). Subsequently, the process proceeds to step S130 of FIG. 4.

However, when it is determined in step S115 that the participation setup process is unsuccessful, the control unit 10 checks the probe responses that have been received so far, and determines whether or not the probe response including the PIN method information has been received even from a wireless communication terminal other than the counterpart wireless communication terminal that has executed the participation setup process (step S116).

When it is determined that the probe response including the PIN method information has not been received from any wireless communication terminal other than the counterpart wireless communication terminal that has executed the participation setup process, the process proceeds to step S102. However, when it is determined that the probe response including the PIN method information has been received from the wireless communication terminal other than the counterpart wireless communication terminal that has executed the participation setup process, the control unit 10 controls the respective components of the wireless communication terminal to execute the participation setup process by the PIN method together with any one wireless communication terminal that has not executed the participation setup process yet among the wireless communication terminals that are transmission sources of the probe response including the PIN method information (step S117). After the participation setup process is finished, the process proceeds to step S115.

FIGS. 4, 5, and 6 mainly illustrate an operation of a wireless communication terminal that has participated in the ad-hoc network. In the wireless communication terminal that has participated in the ad-hoc network, the control unit 10 first starts transmission of the probe response in response to reception of the probe request (step S130). Thereafter, when the probe request is received, in parallel to the processes illustrated in FIGS. 4 to 6, the control unit 10 performs control such that the transmitting unit 14 transmits the probe response including information which is set to be included in (information set to) the probe response at that point in time. The transmitting unit 14 transmits the probe response based on control from the control unit 10.

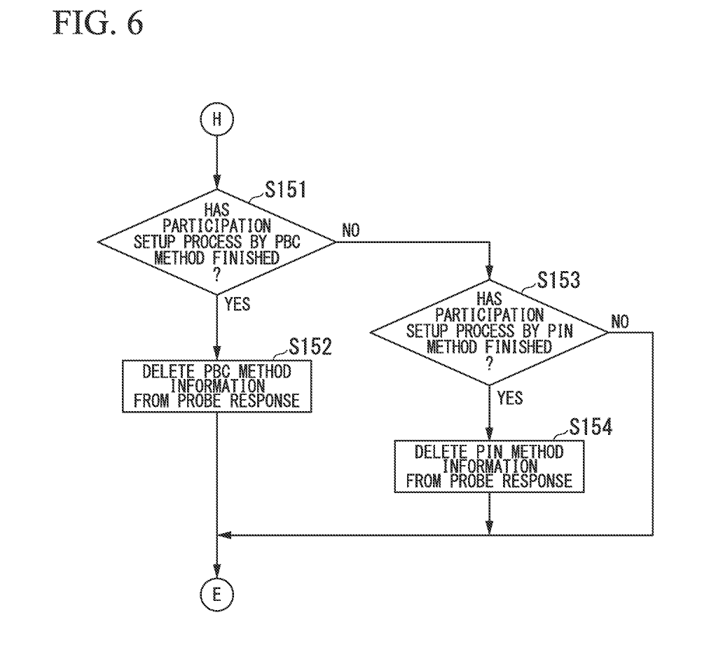

After step S130, the control unit 10 monitors the status of the trigger receiving unit 11, and determines whether or not the trigger for starting the participation setup process by the PBC method has been generated (step S131). When it is determined that the trigger for starting the participation setup process by the PBC method has not been generated, the control unit 10 monitors the status of the trigger receiving unit 11, and determines whether or not the trigger for starting the participation setup process by the PIN method has been generated (step S134). When it is determined that the trigger for starting the participation setup process by the PIN method has not been generated, the process proceeds to step S151 of FIG. 6. However, when it is determined that the trigger for starting the participation setup process by the PIN method has been generated, the control unit 10 sets the setup method of its own wireless communication terminal to the PIN method. In addition, the control unit 10 controls the respective components of the wireless communication terminal to start the participation setup process by the PIN method together with another wireless communication terminal that has generated the trigger for starting the participation setup process by the PIN method (step S135). Thereafter, the participation setup process by the PIN method is performed in parallel to the processes illustrated in FIGS. 4 to 6.

However, when it is determined in step S131 that the trigger for starting the participation setup process by the PBC method has been generated, the control unit 10 sets the setup method of its own wireless communication terminal to the PBC method. In addition, the control unit 10 changes setting of the wireless communication terminal so that the PBC method information can be included in (can be set to) the probe response which will be transmitted later (step S132). Thereafter, when the probe request is received, the control unit 10 performs control such that the transmitting unit 14 transmits the probe response including the PBC method information. The transmitting unit 14 transmits the probe response based on control from the control unit 10.

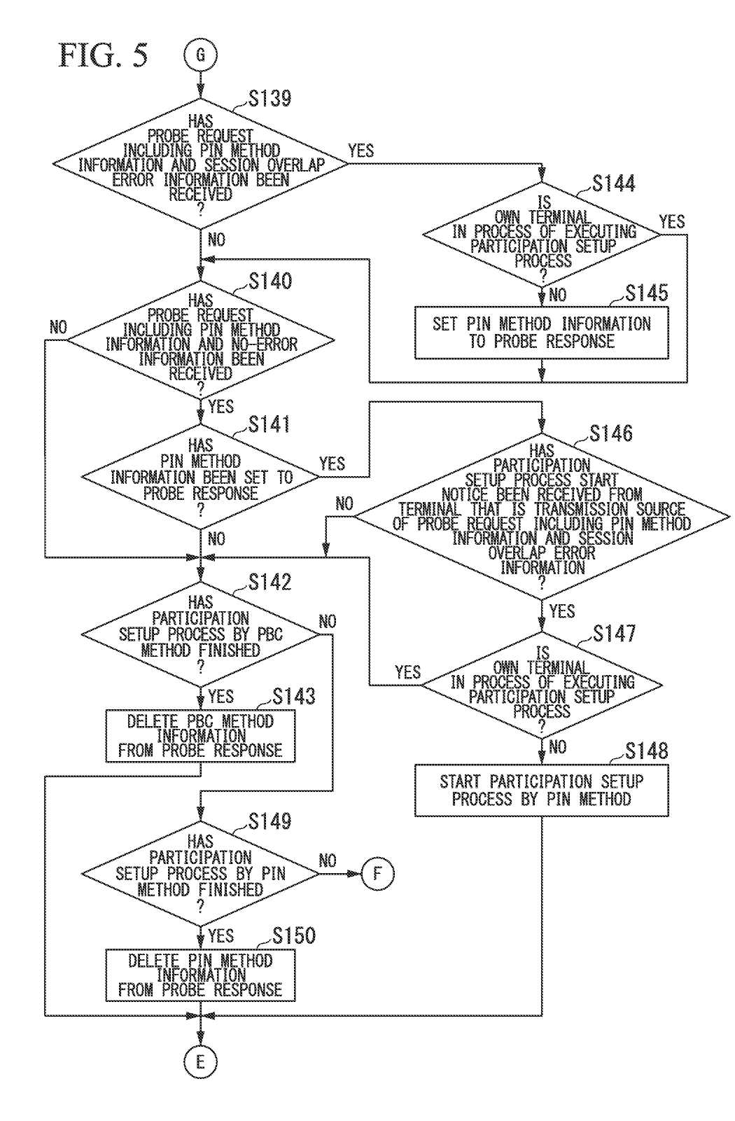

After step S132, the control unit 10 determines whether or not the probe request including the PBC method information has been received from another wireless communication terminal (step S133). When it is determined that the probe request including the PBC method information has not been received from another wireless communication terminal, the process proceeds to step S139 of FIG. 5. However, when it is determined that the probe request including the PBC method information has been received from another wireless communication terminal, the control unit 10 determines whether or not the participation setup process start notice has been received from the wireless communication terminal which is a transmission source of the probe request including the PBC method information (step S136).

When it is determined that the participation setup process start notice has not been received from the wireless communication terminal which is a transmission source of the probe request including the PBC method information, the process proceeds to step S139 of FIG. 5.

However, when it is determined that the participation setup process start notice has been received from the wireless communication terminal which is a transmission source of the probe request including the PBC method information, the control unit 10 determines whether or not its own wireless communication terminal is in the process of executing the participation setup process (step S137).

When it is determined that its own wireless communication terminal is in the process of executing the participation setup process, the process proceeds to step S139 of FIG. 5. However, when it is determined that its own wireless communication terminal is not in the process of executing the participation setup process, the control unit 10 controls the respective components of the wireless communication terminal to start the participation setup process by the PBC method together with the wireless communication terminal that is a transmission source of the probe request including the PBC method information (step S138). Thereafter, the participation setup process by the PBC method is performed in parallel to the processes illustrated in FIGS. 4 to 6. Subsequently, the process proceeds to step S131.

When the process has proceeded to step S139, the control unit 10 determines whether or not the probe request including the PIN method information and the session overlap error information has been received from another wireless communication terminal (step S139). When it is determined that the probe request including the PIN method information and the session overlap error information has not been received from another wireless communication terminal, the process proceeds to step S140. However, when it is determined that the probe request including the PIN method information and the session overlap error information has been received from another wireless communication terminal, the control unit 10 determines whether or not its own wireless communication terminal is in the process of executing the participation setup process (step S144).

When it is determined that its own wireless communication terminal is in the process of executing the participation setup process, the process proceeds to step S140. However, when it is determined that its own wireless communication terminal is not in the process of executing the participation setup process, the control unit 10 sets the setup method of its own wireless communication terminal to the PIN method. In addition, the control unit 10 changes setting of the wireless communication terminal so that the PBC method information can be excluded from the probe response which will be transmitted later and the PIN method information can be included in (can be set to) the probe response (step S145). Thereafter, when the probe request is received, the control unit 10 performs control such that the transmitting unit 14 transmits the probe response including the PIN method information. The transmitting unit 14 transmits the probe response based on control from the control unit 10. Subsequently, the process proceeds to step S140.

When a plurality of wireless communication terminals that perform the participation setup process by the PBC method are detected, the wireless communication terminal that does not participate in the ad-hoc network sets its own setup method to the PIN method, and transmits the probe request including the PIN method information and the session overlap error information in step S112. Among the participating wireless communication terminals in the ad-hoc network, which have received the probe request, the wireless communication terminal, which is not in the process of executing the participation setup process, changes its own setup method to the PIN method in step S145. As a result, the wireless communication terminal that does not participate in the ad-hoc network can perform the participation setup process by the PIN method together with the participating wireless communication terminal in the ad-hoc network, which has received the probe request.

When the process has proceeded to step S140, the control unit 10 determines whether or not the probe request including the PIN method information and the no-error information has been received from another wireless communication terminal (step S140). When it is determined that the probe request including the PIN method information and the no-error information has not been received from another wireless communication terminal, the process proceeds to step S142. However, when it is determined that the probe request including the PIN method information and the no-error information has been received from another wireless communication terminal, the control unit 10 determines whether or not the wireless communication terminal has been set to include the PIN method information in the probe response (step S141).

When it is determined that the wireless communication terminal has not been set to include the PIN method information in the probe response, the process proceeds to step S142. However, when it is determined that the wireless communication terminal has been set to include the PIN method information in the probe response, the control unit 10 determines whether or not the participation setup process start notice has been received from the wireless communication terminal that is a transmission source of the probe request including the PIN method information and the session overlap error information (step S146).

When it is determined that the participation setup process start notice has not been received from the wireless communication terminal that is a transmission source of the probe request including the PIN method information, the process proceeds to step S142. However, when it is determined that the participation setup process start notice has been received from the wireless communication terminal that is a transmission source of the probe request including the PIN method information, the control unit 10 determines whether or not its own wireless communication terminal is in the process of executing the participation setup process (step S147).

When it is determined that its own wireless communication terminal is in the process of executing the participation setup process, the process proceeds to step S142. However, when it is determined that its own wireless communication terminal is not in the process of executing the participation setup process, the control unit 10 controls the respective components of the wireless communication terminal to start the participation setup process by the PIN method together with the wireless communication terminal that is a transmission source of the probe request including the PIN method information (step S148). Thereafter, the participation setup process by the PIN method is performed in parallel to the processes illustrated in FIGS. 4 to 6. Subsequently, the process proceeds to step S131.

When the process has proceeded to step S142, the control unit 10 determines whether or not the participation setup process by the PBC method has been finished (step S142). When it is determined that the participation setup process by the PBC method has been finished, the control unit 10 changes the setting of the wireless communication terminal so that the PBC method information can be excluded from the probe response which will be transmitted later (step S143). Subsequently, the process proceeds to step S131.

Meanwhile, when it is determined in step S142 that the participation setup process by the PBC method is being executed or when the participation setup process by the PBC method is not executed yet, the control unit 10 determines whether or not the participation setup process by the PIN method has finished (step S149). When it is determined that the participation setup process by the PIN method has finished, the control unit 10 changes setting of the wireless communication terminal so that the PIN method information can be excluded from the probe response which will be transmitted later (step S150). Subsequently, the process proceeds to step S131. However, when it is determined that the participation setup process by the PIN method is being executed or when the participation setup process by the PIN method is not executed yet, the process proceeds to step S133.

Meanwhile, when it is determined in step S134 that the trigger for starting the participation setup process by the PIN method has not been generated, the control unit 10 determines whether or not the participation setup process by the PBC method has finished (step S151). When it is determined that the participation setup process by the PBC method has finished, the control unit 10 changes setting of the wireless communication terminal so that the PBC method information can be excluded from the probe response which will be transmitted later (step S152). Subsequently, the process proceeds to step S131.

When it is determined in step S151 that the participation setup process by the PBC method is being executed or that the participation setup process by the PBC method is not executed yet, the control unit 10 determines whether or not the participation setup process by the PIN method has finished (step S153). When it is determined that the participation setup process by the PIN method has finished, the control unit 10 changes the setting of the wireless communication terminal so that the PIN method information can be excluded from the probe response which will be transmitted later (step S154). Subsequently, the process proceeds to step S131. However, when the participation setup process by the PIN method is being executed or when the participation setup process by the PIN method has not been executed yet, the process proceeds to step S131.

Next, a description will be made in connection with an example of an operation of a wireless communication terminal according to the process illustrated in FIGS. 2 to 6. FIG. 7 illustrates a first operation example. FIG. 7 illustrates an example in which, in a state in which an ad-hoc network is already present, and a wireless communication terminal 1 and a wireless communication terminal 2 are located in the ad-hoc network, in order to cause a non-participating wireless communication terminal 3 and a non-participating wireless communication terminal 4 to participate in the ad-hoc network, a user pushes buttons of the wireless communication terminal 1 and the wireless communication terminal 3, and then the user further pushes buttons of the wireless communication terminal 2 and the wireless communication terminal 4.

When the button is pushed down in the wireless communication terminal 1 (corresponding to step S131), the wireless communication terminal 1 sets the PBC method information to the probe response (corresponding to step S132). Further, when the button is pushed down in the non-participating wireless communication terminal 3 (corresponding to step S102), the wireless communication terminal 3 transmits the probe request including the PBC method information (corresponding to step S103).

The wireless communication terminal 1 replies with the probe response including the PBC method information in response to the probe request from the wireless communication terminal 3 (corresponding to step S130). Since the button has not been pushed down in the wireless communication terminal 2, the wireless communication terminal 2 replies with the probe response in which neither the PBC method information nor the PIN method information is set (corresponding to step S130).

When the probe response including the PBC method information is received from the wireless communication terminal 1 (corresponding to step S104), since the probe response including the PBC method information has not been received from the wireless communication terminal 2 (corresponding to step S105), the wireless communication terminal 3 executes the participation setup process by the PBC method with the wireless communication terminal 1 (corresponding to step S106).

After the probe request including the PBC method information is received from the wireless communication terminal 3 (corresponding to step S133), the wireless communication terminal 1 receives the participation setup process start notice from the wireless communication terminal 3 (corresponding to step S136). Since the wireless communication terminal 1 is not in the process of executing the participation setup process (corresponding to step S137), the wireless communication terminal 1 executes the participation setup process by the PBC method with the wireless communication terminal 3 (corresponding to step S138).

Meanwhile, when the button is pushed down in the wireless communication terminal 2 (corresponding to step S131), the wireless communication terminal 2 sets the PBC method information to the probe response (corresponding to step S132). Further, when the button is pushed down in the non-participating wireless communication terminal 4 (corresponding to step S102), the wireless communication terminal 4 transmits the probe request including the PBC method information (corresponding to step S103).

The wireless communication terminal 1 and the wireless communication terminal 2 reply with the probe response to which the PBC method information is set in response to the probe request from the wireless communication terminal 4 (corresponding to step S130). When the probe responses including the PBC method information are received from the wireless communication terminal 1 and the wireless communication terminal 2 (corresponding to steps S104 and S105), the wireless communication terminal 4 transmits the probe request including the PIN method information and the session overlap error information (corresponding to step S112).

The wireless communication terminal 1 replies with the probe response including the PBC method information in response to the probe request from the wireless communication terminal 4 since the participation setup process by the PBC method is being executed (since the participation setup process started in step S138 is being executed). After the probe request including the PIN method information and the session overlap information has been received from the wireless communication terminal 4 (corresponding to step S139), the wireless communication terminal 2 replies with the probe response. Since the wireless communication terminal 2 is not in the process of executing the participation setup process (corresponding to step S144), the wireless communication terminal 2 clears the PBC method information from the probe response, and sets the PIN method information (corresponding to step S145).

In the example of FIG. 7, the wireless communication terminal 2 replies with the probe response in response to the probe request including the PIN method information and the session overlap information before setting the PIN method information. However, the wireless communication terminal 2 may set the PIN method information before replying with the probe response.

Since the wireless communication terminal 4 has received the probe response including the PBC method information rather than the PIN method information (corresponding to steps S113 and S119), the wireless communication terminal 4 transmits the probe request including the PIN method information and the no-error information (corresponding to step S120). Since the wireless communication terminal 1 is in the process of executing the participation setup process (corresponding to step S138), the wireless communication terminal 1 replies with the probe response including the PBC method information in response to the probe request from the wireless communication terminal 4.

However, when the probe request including the PIN method information and the no-error information is received from the wireless communication terminal 4 (corresponding to step S140), the wireless communication terminal 2 replies with the probe response including the PIN method information (corresponding to step S130 and S145). Since the wireless communication terminal 4 receives the probe response including the PIN method information from the wireless communication terminal 2 (corresponding to step S113), the wireless communication terminal 4 executes the participation setup process by the PIN method with the wireless communication terminal 2 (corresponding to step S114).

When the participation setup process start notice is received from the wireless communication terminal 4 (corresponding to step S146), since the wireless communication terminal 2 is not in the process of executing the participation setup process (corresponding to step S147), the wireless communication terminal 2 executes the participation setup process by the PIN method with the wireless communication terminal 4 (corresponding to step S148).

When the participation setup process with the wireless communication terminal 1 is successful (corresponding to step S107), the wireless communication terminal 3 participates in the ad-hoc network according to the network setup information acquired during the participation setup process (corresponding to step S108), and then operates as a wireless communication terminal within the ad-hoc network. When the participation setup process with the wireless communication terminal 3 is successful (corresponding to step S151), the wireless communication terminal 1 deletes the PBC method information from the probe response (corresponding to step S152).

When the participation setup process with the wireless communication terminal 2 is successful (corresponding to step S115), the wireless communication terminal 4 participates in the ad-hoc network according to the network setup information acquired during the participation setup process (corresponding to step S118), and then operates as a wireless communication terminal within the ad-hoc network. When the participation setup process with the wireless communication terminal 4 is successful, the wireless communication terminal 2 deletes the PIN method information from the probe response (corresponding to step S154).

In the example of FIG. 7, the button is first pushed down in the wireless communication terminal within the ad-hoc network regarding the operation between the wireless communication terminal 1 and the wireless communication terminal 3 or between the wireless communication terminal 2 and the wireless communication terminal 4. However, the button may be first pushed down in the non-participating wireless communication terminal. In this case, the non-participating wireless communication terminal repeats an operation of transmitting the probe request including the PBC method information and an operation of waiting for reception of the probe response including the PBC method information.

As described above, the user can execute the participation setup process by pushing the buttons of the wireless communication terminal 2 and the wireless communication terminal 4 without waiting for completion of the participation setup process between the wireless communication terminal 1 and the wireless communication terminal 3. Thus, a time in which the user is tied down is reduced. In addition, the participation setup process between the wireless communication terminal 1 and the wireless communication terminal 3 can be executed in parallel to the participation setup process between the wireless communication terminal 2 and the wireless communication terminal 4. Thus, a time taken until participation of all non-participating wireless communication terminals is completed can be reduced.

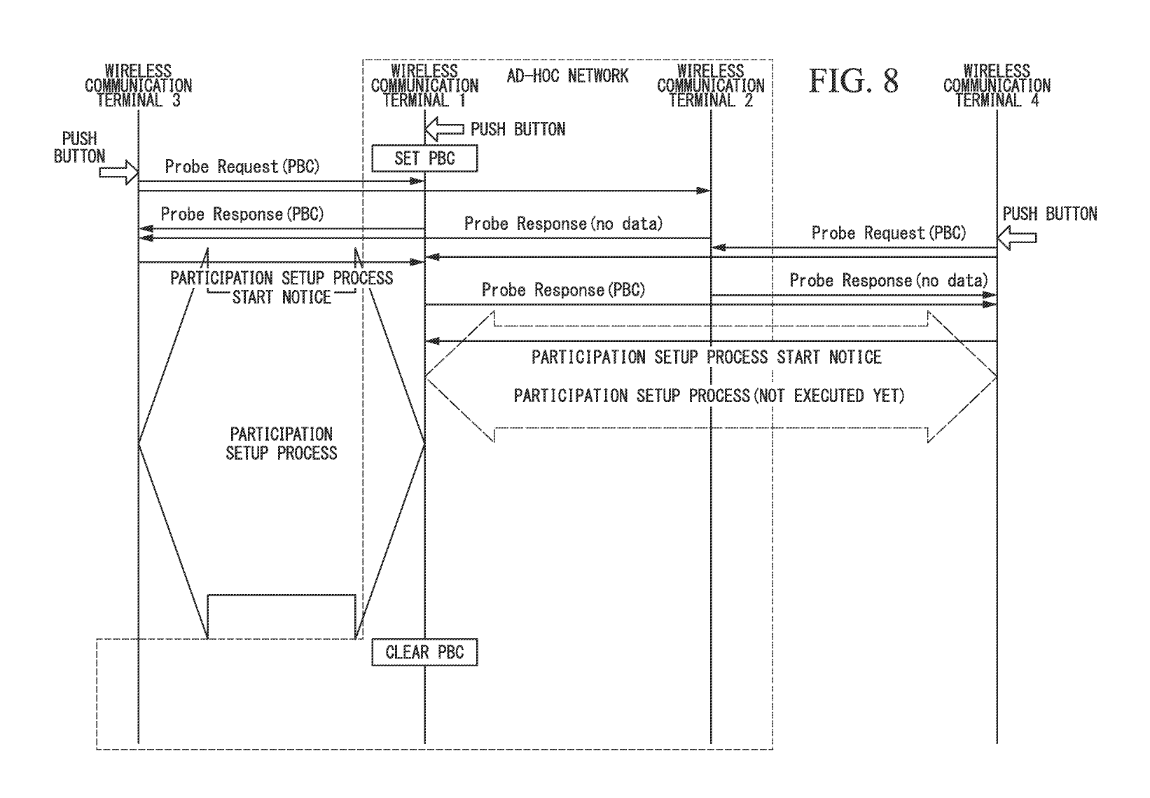

FIG. 8 illustrates a second operation example. FIG. 8 illustrates an example in which, in a state in which the ad-hoc network is already present, and the wireless communication terminal 1 and the wireless communication terminal 2 are located in the ad-hoc network, when a user pushes buttons of the wireless communication terminal 1 and the wireless communication terminal 3 in order to cause a non-participating wireless communication terminal 3 to participate in the ad-hoc network, another user having malicious intent continuously pushes a button of the wireless communication terminal 4 in order to illegally participate in the ad-hoc network. In the following, a description of the same parts as in FIG. 7 will not be made.

An operation until the buttons of the wireless communication terminal 1 and the wireless communication terminal 3 are pushed down and the participation setup process by the PBC method is executed between the wireless communication terminal 1 and the wireless communication terminal 3 is the same as in FIG. 7. When the button is pushed down in the non-participating wireless communication terminal 4 (corresponding to step S102), the wireless communication terminal 4 transmits the probe request including the PBC method information (corresponding to step S103). In response to the probe request transmitted from the wireless communication terminal 4, the wireless communication terminal 1 replies with the probe response to which the PBC method information is set, and the wireless communication terminal 2 replies with the probe response to which neither the PBC method information nor the PIN method information is set (corresponding to step S130).

The wireless communication terminal 4 receives the probe response including the PBC method information from the wireless communication terminal 1 (corresponding to step S104), but receives the probe response including no PBC method information from the wireless communication terminal 2 whose button has not been pushed down (corresponding to step S105). Thus, the wireless communication terminal 4 executes the participation setup process by the PBC method with the wireless communication terminal 1 (corresponding to step S106). The wireless communication terminal 1 receives the participation setup process start notice from the wireless communication terminal 4, but does not perform the participation setup process with the wireless communication terminal 4 (corresponding to steps S131, S134, S151, and S153). Thus, the participation setup process is not successful (corresponding to step S107), and the wireless communication terminal 4 cannot participate in the ad-hoc network.

As described above, even when the user having malicious intent pushes the button of the wireless communication terminal that does not participate in the ad-hoc network in order to illegally participate in the ad-hoc network in a state in which the participation setup process by the PBC method is being executed between the wireless communication terminals, unauthorized participation in the ad-hoc network can be prevented.

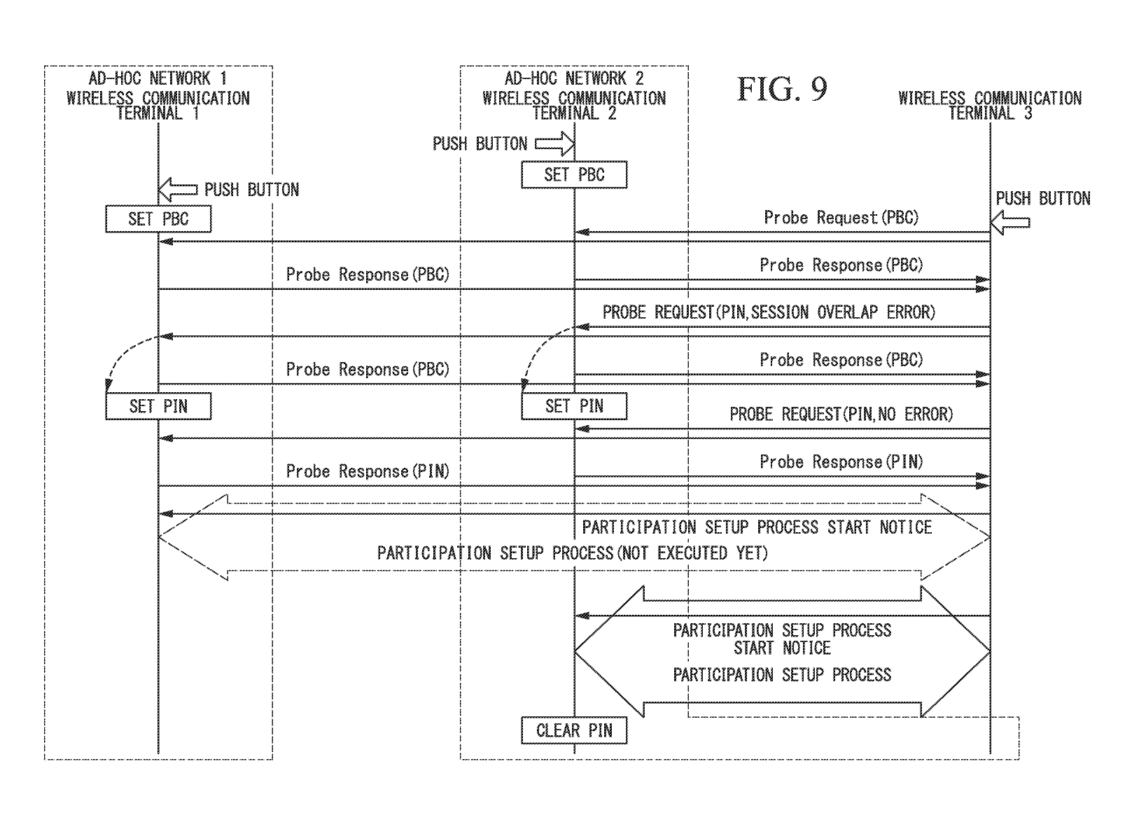

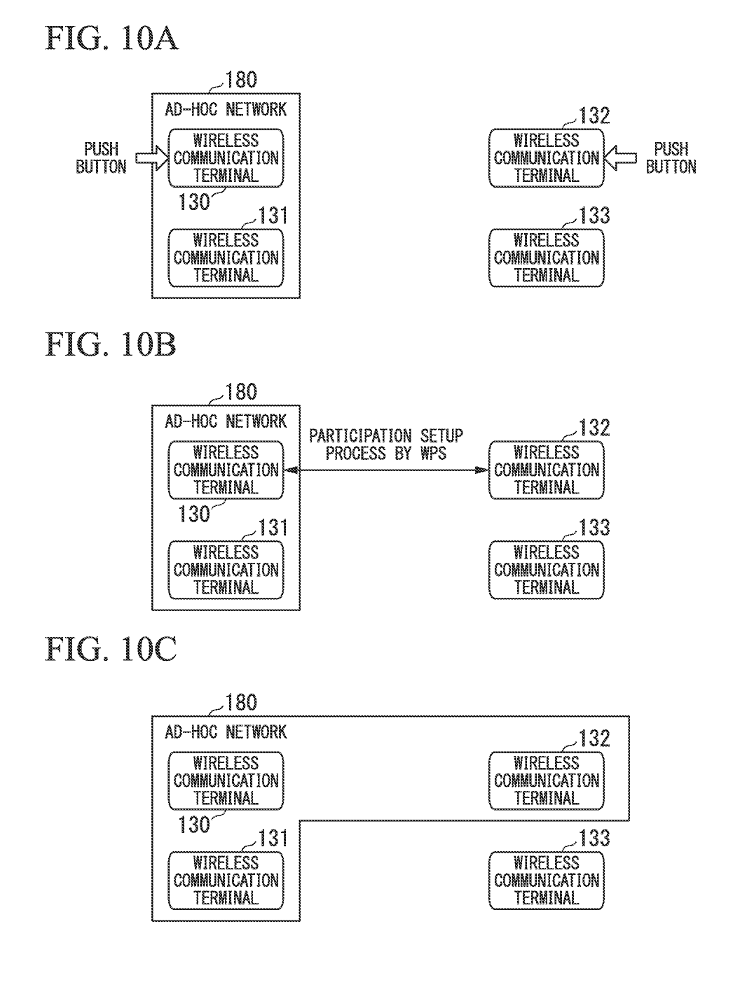

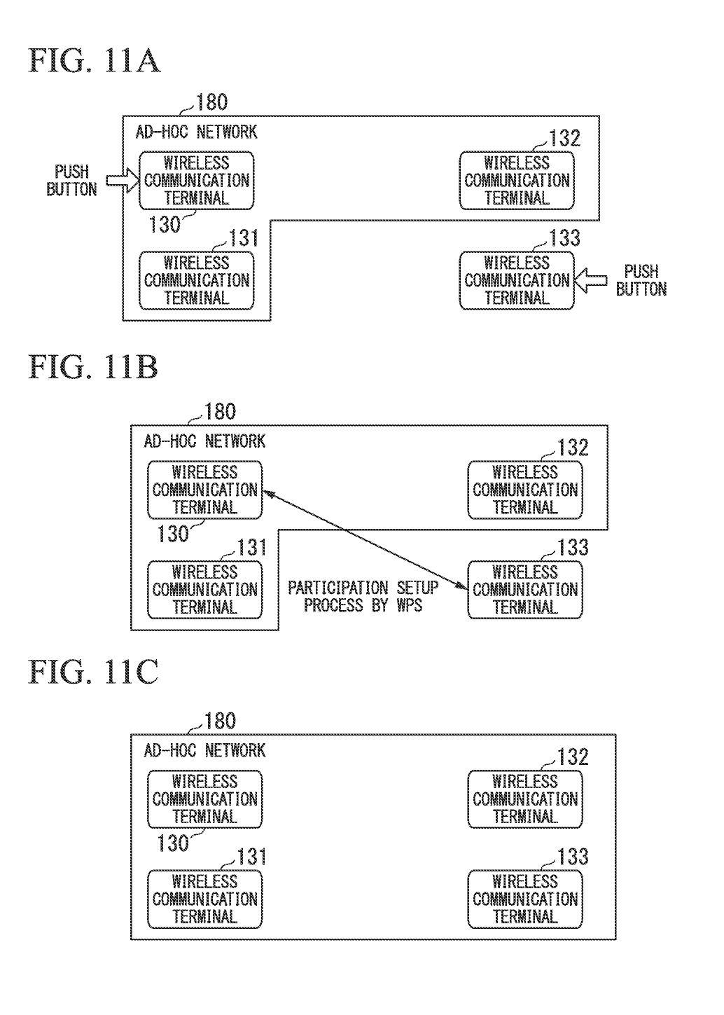

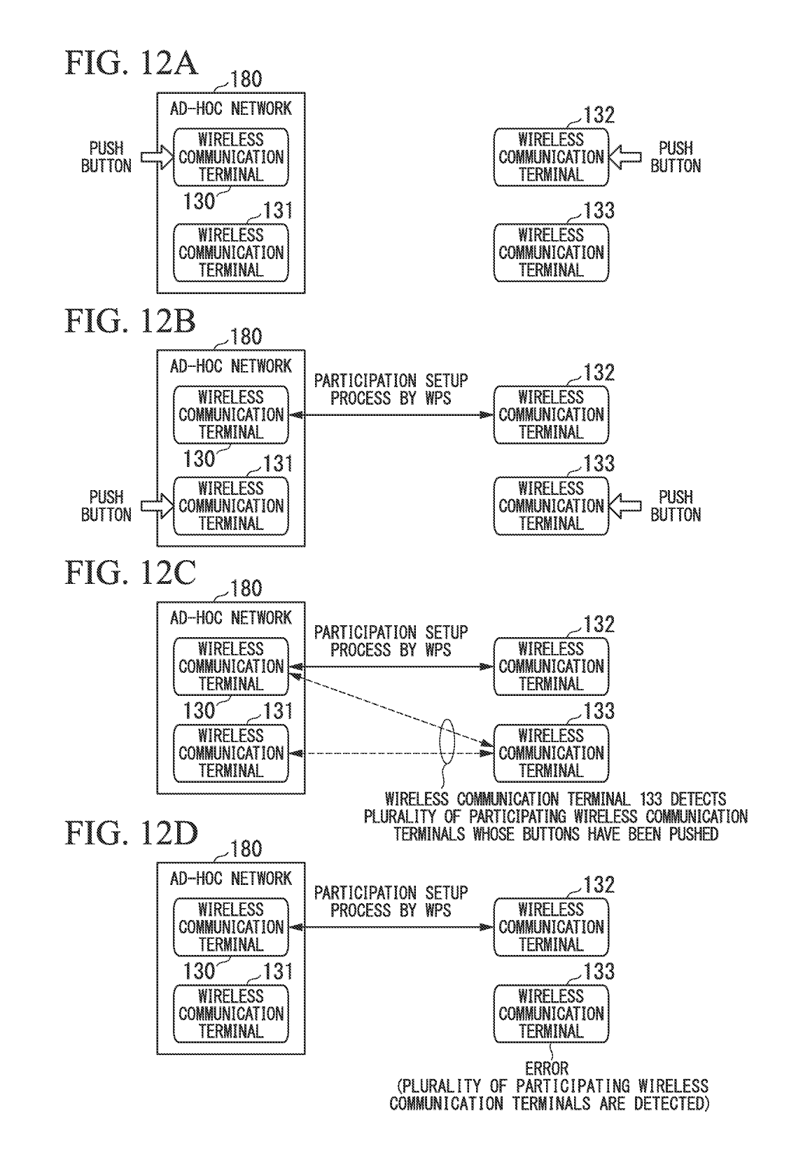

FIG. 9 illustrates a third operation example. In FIG. 9, a state in which an ad-hoc network 1 and an ad-hoc network 2 are already present, the wireless communication terminal 1 is located in the ad-hoc network 1, and the wireless communication terminal 2 is located in the ad-hoc network 2 is set as an initial state. In addition, FIG. 9 illustrates an example in which when a normal user pushes a button of the wireless communication terminal 2 in order to cause the non-participating wireless communication terminal 3 to participate in the ad-hoc network 2, another user having malicious intent pushes a button of the wireless communication terminal 1 located in the ad-hoc network 1 before the button of the wireless communication terminal 3 is pushed down in order to induce the wireless communication terminal 3 to its unauthorized ad-hoc network 1. In the following, a description of the same part as in FIG. 7 will not be made.

When the buttons are pushed down in the wireless communication terminal 1 and the wireless communication terminal 2 (corresponding to step S131), the wireless communication terminal 1 and the wireless communication terminal 2 set the PBC method information to the probe response (corresponding to step S132). When the button is pushed down in the non-participating wireless communication terminal 3 (corresponding to step S102), the wireless communication terminal 3 transmits the probe request including the PBC method information (corresponding to step S103).

The wireless communication terminal 1 and the wireless communication terminal 2 reply with the probe response to which the PBC method information is set in response to the probe request from the wireless communication terminal 3 (corresponding to step S130). When the probe responses including the PBC method information are received from the wireless communication terminal 1 and the wireless communication terminal 2 (corresponding to steps S104 and S105), the wireless communication terminal 3 transmits the probe request including the PIN method information and the session overlap error information (corresponding to step S112).

After receiving the probe request including the PIN method information and the session overlap information from the wireless communication terminal 3 (corresponding to step S139), since the wireless communication terminal 1 and the wireless communication terminal 2 are not in the process of executing the participation setup process (corresponding to step S144), the wireless communication terminal 1 and the wireless communication terminal 2 clear the PBC method information from the probe response, and set the PIN method information (corresponding to step S145). Since the wireless communication terminal 3 has received the probe responses including the PBC method information rather than the PIN method information from the wireless communication terminal 1 and the wireless communication terminal 2 (corresponding to steps S113 and S119), the wireless communication terminal 3 transmits the probe request including the PIN method information and the no-error information (corresponding to step S120).

When the probe request including the PIN method information and the no-error information is received from the wireless communication terminal 3 (corresponding to step S140), the wireless communication terminal 1 and the wireless communication terminal 2 reply with the probe response including the PIN method information (corresponding to steps S130 and S145). When the probe responses including the PIN method information are received from the wireless communication terminal 1 and the wireless communication terminal 2 (corresponding to step S113), the wireless communication terminal 3 executes the participation setup process with any one of the wireless communication terminals that are transmission sources of the probe response. In this example, the wireless communication terminal 3 first executes the participation setup process with the wireless communication terminal 1 (corresponding to step S114).

When the wireless communication terminal 1 has received the probe request including the PIN method information and the no-error information from the wireless communication terminal 3, the PIN method information has already set to the probe response (corresponding to step S141). The wireless communication terminal 1 receives the participation setup process start notice from the wireless communication terminal 3 (corresponding to step S146), and executes the participation setup process by the PIN method (corresponding to step S148) since the wireless communication terminal 1 is not in the process of executing the participation setup process (corresponding to step S147).

Here, the participation setup process by the PIN method between the wireless communication terminal 1 and the wireless communication terminal 3 is performed such that a PIN code displayed on one wireless communication terminal is input to the other wireless communication terminal. Since the normal user pushed the buttons on the wireless communication terminal 3 and the wireless communication terminal 2 in order to cause the wireless communication terminal 3 to join the ad-hoc network 2 to which the wireless communication terminal 2 belongs, the normal user reads and inputs the PIN code between the wireless communication terminal 3 and the wireless communication terminal 2. For this reason, the PIN code is not properly read and input between the wireless communication terminal 1 and the wireless communication terminal 3, and thus the participation setup process is unsuccessful. Thus, the wireless communication terminal 3 does not participate in the unauthorized ad-hoc network 1.

When the participation setup process with the wireless communication terminal 1 is unsuccessful (corresponding to step S115), the probe response including the PIN method information has also been received from the wireless communication terminal 2 (corresponding to step S116), and so the wireless communication terminal 3 executes the participation setup process by the PIN method with the wireless communication terminal 2 (corresponding to step S117).

When the participation setup process with the wireless communication terminal 2 is successful (corresponding to step S115), the wireless communication terminal 3 participates in the ad-hoc network according to the network setup information acquired during the participation setup process (corresponding to step S118), and then operates as a wireless communication terminal within the ad-hoc network. When the participation setup process with the wireless communication terminal 3 is successful (corresponding to step S153), the wireless communication terminal 2 deletes the PIN method information from the probe response (corresponding to step S154).

As described above, even when the user having malicious intent pushes the button on the wireless communication terminal that has participated in the ad-hoc network in order to induce the wireless communication terminal of the normal user to its own unauthorized ad-hoc network in a state in which the normal user is trying to execute the participation setup process by the PBC method with a desired wireless communication terminal, the normal user's wireless communication terminal can be prevented from participating in the unauthorized ad-hoc network different from the desired ad-hoc network.

As described above, according to the first preferred embodiment, in the case in which the user adds a plurality of non-participating wireless communication terminals to an existing ad-hoc network based on the PBC method of WPS, when the wireless communication terminal that does not participate in the ad-hoc network detects that a plurality of wireless communication terminals in the ad-hoc network are operating based on the PBC method, the setup method is changed to the PIN method in the non-participating wireless communication terminal and in the wireless communication terminal that is not in the process of executing the participation setup process within the ad-hoc network. As a result, a time in which the user is constrained to wait to push the button, that is, the standby time of the participation setup process, can be reduced, and a time taken until participation of all of non-participating wireless communication terminals is completed can be reduced.

Furthermore, in the first preferred embodiment, the wireless communication terminal that does not participate in the ad-hoc network transmits the probe request including the session overlap error information (corresponding to step S112). Thereafter, when the probe response is received from the wireless communication terminal that has participated in the ad-hoc network (corresponding to step S113), the wireless communication terminal that does not participate in the ad-hoc network executes the participation setup process, and transmits the participation setup process start notice (corresponding to step S114). Meanwhile, the wireless communication terminal that has participated in the ad-hoc network is on standby for the participation setup process until the participation setup process start notice is received from the wireless communication terminal that is a transmission source of the probe request including the session overlap error information (corresponding to step S146).

Thus, even when the setup method is changed from the PBC method to the PIN method in both of the wireless communication terminal that has participated in the ad-hoc network and the wireless communication terminal that does not participate in the ad-hoc network, the participation setup process by the PIN method is preferentially performed between the two wireless communication terminals. For example, even if another user tries to start a new participation setup process by the PIN method in order to add the non-participating wireless communication terminal to the ad-hoc network directly after the setup method is changed from the PBC method to the PIN method in the two wireless communication terminals between which the participation setup process has to be preferentially performed, the participation setup process start notice from the non-participating wireless communication terminal is not received by the wireless communication terminal that is in the process of executing the participation setup process until the participation setup process is finished between the two wireless communication terminals between which the participation setup process has to be preferentially performed. Thus, the standby time of the user who was first on standby for execution of the participation setup process by the PBC method can be reduced.

While preferred embodiments of the present invention have been described and illustrated above, it should be understood that these are examples of the present invention and are not to be considered as limiting. Additions, omissions, substitutions, and other modifications can be made without departing from the scope of the present invention. Accordingly, the present invention is not to be considered as being limited by the foregoing description, and is only limited by the scope of the claims.

What is claimed is:

1. A wireless communication terminal, wherein a process, in which an authentication identifier necessary for participating in a wireless network is a fixed value, is set as a first setup process, and a process, in which the authentication identifier is variable, is set as a second setup process in a participation setup process, which a non-participating wireless communication terminal, which does not participate in the wireless network, performs with a wireless communication terminal, which is participating in the wireless network, in order to participate in the wireless network, the wireless communication terminal comprising:
a trigger receiving unit that receives a trigger for starting the first setup process in a state in which the wireless communication terminal does not participate in the wireless network;
a transmitting unit that transmits an acquisition request of setup information representing a participation setup process performed by another wireless communication terminal after receiving the trigger;
a receiving unit that receives a response including the setup information transmitted from the other wireless communication terminal that has received the acquisition request; and
a control unit that performs control such that the transmitting unit transmits error information representing that a plurality of wireless communication terminals performing the first setup process are detected to the plurality of wireless communication terminals, and performs control such that the participation setup process performed by its own wireless communication terminal is set as the second setup process when responses including the setup information representing the first setup process are received from the plurality of wireless communication terminals.

2. The wireless communication terminal according to claim 1, wherein, when a response is received from at least one of the plurality of wireless communication terminals in response to the error information transmitted by the transmitting unit, the control unit performs control such that the transmitting unit transmits start information representing a start of the second setup process to a wireless communication terminal that has transmitted the response to the error information.

3. A wireless communication terminal, wherein a process, in which an authentication identifier necessary for participating in a wireless network is a fixed value, is set as a first setup process, and a process, in which the authentication identifier is not a fixed value, is set as a second setup process in a participation setup process, which a non-participating wireless communication terminal, which does not participate in the wireless network, performs with a wireless communication terminal, which is participating in the wireless network, in order to participate in the wireless network, the wireless communication terminal comprising:
a trigger receiving unit that receives a trigger for starting the first setup process in a state in which the wireless communication terminal is participating in the wireless network;
a receiving unit that receives an acquisition request of setup information representing a participation setup process performed by another wireless communication terminal from the non-participating wireless communication terminal after receiving the trigger;
a transmitting unit that transmits a response including the setup information representing the first setup process to the non-participating wireless communication terminal when the acquisition request is received; and
a control unit that performs control such that the participation setup process performed by its own wireless communication terminal is set as the second setup process when the receiving unit receives error information representing that a plurality of wireless communication terminals performing the first setup process are detected in a state in which the wireless communication terminal is not executing the first setup process with any of wireless communication terminals that do not participate in the wireless network.

4. The wireless communication terminal according to claim 3, wherein the control unit performs control of waiting for a start of the second setup process until the receiving unit receives start information representing a start of the second setup process from a wireless communication terminal that is a transmission source of the error information.
